(19) United States
(12) Patent Application Publication
(10) Pub. No.: US 2003/0178792 A1
(43) Pub. Date: Sep. 25, 2003

(54) Sealing head

(76) Inventor: Ken T. Pridmore, South Lyon, MI (US)

Correspondence Address: FROMMER LAWRENCE & HAUG, 745 FIFTH AVENUE- 10TH FL., NEW YORK, NY, 10151, US

(21) Appl. No.: 10/396,802

(22) Filed: Mar. 24, 2003

(30) Foreign Application Priority Data
Mar. 25, 2002 (DE) 102 13 311.5

(51) Int. Cl. F16J 15/02

(52) U.S. Cl. 277/628

(57) ABSTRACT

A sealing head for temporarily providing a pressurized-gas-tight seal for openings, with a base plate on which is mounted a peripheral seal that is kept closed in the circumferential direction, wherein the seal is a flexible lip seal, the sealing lip of which in the no-load condition protrudes from the base plate in such a way that it is facing an inside of the sealing head, which is enclosed by the sealing lip.

### BACKGROUND

The invention relates to a sealing head for temporarily providing a pressurized-gas-tight seal for openings, with a base plate on which is mounted a peripheral seal that is kept closed in the circumferential direction.

In tightness tests under pressure, such as leak or cold tests on sealed modules which are exposed to pressure, it is necessary, as a rule, to seal one or more openings in the module to be tested for the duration of the tightness test, so that a test medium such as compressed air can be introduced and a pressure can build up, which then permits an assessment of the tightness. As a rule, devices known as sealing heads are used for this purpose. These have, first of all, a base plate corresponding to the geometry (shape and size) of the opening to be sealed, which usually consists of metal, and, secondly, a suitable circumferential seal connected to the base plate, which is formed, in known embodiments, by an O-ring. With a sealing head of this kind, it is possible, for example, to create a temporary pressurized-gas-tight seal for an exhaust port opening during a tightness test on a cylinder head, by urging a sealing head - with a seal that is a little larger than the exhaust port opening - against the sealing face surrounding the exhaust port opening. Any slight unevenness, roughness etc. is compensated by the elasticity of the O-ring. Then pressurized gas can be introduced into the cylinder chamber via an inlet port opening. This can likewise be done with the aid of a sealing head with an opening and an inlet pipe connected to it which also seals the inlet port opening.

Sealing heads of this kind have in principle stood the test of practice, but they do have disadvantages in that their sealing effect declines sharply in the case of higher pressures and/or uneven or rough patches in the area of the sealing face. In order to ensure that there is a perfect sealing effect, considerable contact pressure is needed, which is often many times greater than the forces resulting from the static internal pressure.

The object of the invention therefore consists in improving a sealing head of the generic type in such a way that a perfect sealing effect can still be achieved when there are certain uneven or rough patches in the area of the sealing face. In this way, there is a certain bridging capacity without the need for a considerable contact pressure.

This object is achieved, in accordance with the invention, by a sealing head of the generic type, in that the seal is designed as a flexible lip seal. The sealing lip in the no-load condition protrudes from the base plate in such a way that it is facing an internal region of the sealing head, which is enclosed by the sealing lip.

As will be explained in more detail in connection with the description of a working embodiment, a considerable capacity for bridging uneven patches is achieved by means of this surprisingly simple measure, with a contact pressure that is virtually negligible.

The arrangement is preferably such that the sealing lip protrudes from the base plate at an acute angle.

The invention preferably provides that the sealing lip protrudes from the base plate at an angle of about 30° to 60°, preferably about 45°.

The sealing lip can be vulcanized or bonded to a land projecting from the base plate like a flange. The sealing lip preferably consists of an elastic material, such as rubber or an elastomer.

It is advisable for the sealing lip to have a tapering cross-section.

### SUMMARY

In a preferred embodiment, the sealing lip is provided so that it extends in one plane. Alternatively, the sealing lip can be provided to extend along a curved, and in particular a cylinder-jacket-shaped surface in order, for example, to seal openings which are located directly in a cylinder wall.

In this case, it can be provided that the base plate also extends along a curved, and in particular a cylinder-jacket-shaped, surface.

In one embodiment of the invention, the base plate is provided to have at least one opening and/or at least one pressurized gas connection, in order to introduce or vent a pressurized gas in a controlled manner.

The base plate preferably consists of metal or plastic. In a modified version, the base plate and lip seal are manufactured integrally from a suitable plastic material.

### BRIEF DESCRIPTION OF THE DRAWINGS

The invention will now be explained by means of a working embodiment, with reference to a drawing, in which:

FIG. 1 shows a plan view of a sealing head of the invention;

FIG. 2 shows a section view along line II-II in FIG. 1, and

FIG. 3 shows an enlarged detailed representation of the lip seal from FIG. 2.

### DETAILED DESCRIPTION

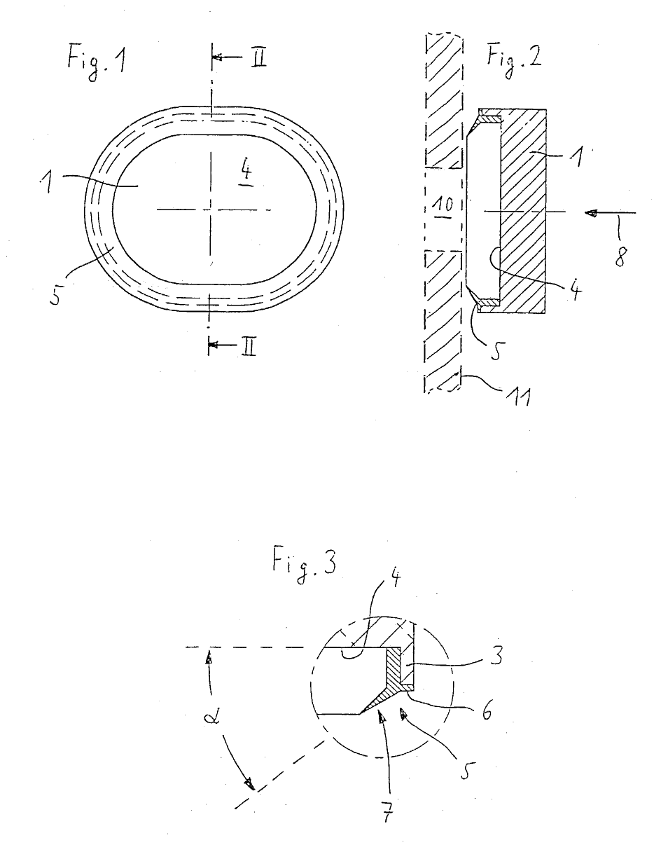

FIGS. 1 to 3 illustrate an embodiment of a sealing head of the invention which has an oval-shaped base plate 1 that is closed, i.e. it has no openings, and has an inside 4 enclosed by a projecting land 3. As FIG. 3 clearly shows, a lip seal 5 is inserted from inside against the land 3 of the base plate 1 and extends over the latter with a flange-like neck 6, the lip seal 5 being conveniently bonded to the land or vulcanized to it if it is made of rubber.

The lip seal 5 has a sealing lip 7 protruding towards the inside 4 of the base plate 1. The lip seal is tapered and extends at an angle α of about 45° to the plane of the inside 4.

As is indicated in FIG. 2, when the sealing head is in use, it is first placed in the direction of the arrow 8 against the sealing face 11 surrounding an opening 10 to be sealed on a device to be tested for tightness. Very slight contact pressure, e.g. in the region of 5 to 10 N is sufficient in the case of a sealing head with an average diameter of about 5 cm.

This contact pressure, which is extremely slight in comparison to conventional sealing heads sealed by means of O-rings, is lower by a factor of about 100 than hitherto, and can be explained by the fact that the static pressure which is built up in the region between the inside 4, the lip seal 5 and the opening 10 during the subsequent tightness test has a tendency to urge the sealing lip 7 of the lip seal both in the direction of the sealing face 11 and radially outwards, so that, as the sealing lip 7 is pressed against the sealing face 11, it reinforces its own pressure. Basically, therefore, the sealing head or the base plate 1 merely needs to be pressed against the sealing face 11 (arrow 8) with sufficient force to compensate the static pressure, so that the load on the device tested is reduced accordingly.

What is claimed is:

1. A sealing head for temporarily providing a pressurized-gas-tight seal for an opening having a base plate on which is mounted a peripheral seal that is kept closed in the circumferential direction, wherein the seal is a flexible lip seal having the sealing lip which in the no-load condition protrudes from the base plate in such a way that it is facing an inside of the sealing head which is enclosed by said sealing lip.

2. The sealing head as claimed in claim 1, wherein said sealing lip protrudes from the base plate at an acute angle.

3. The sealing head as claimed in claim 2, wherein said sealing lip protrudes from the base plate at an angle of about 30° to 60°.

4. The sealing head as claimed in claim 2 wherein said sealing lip protrudes from the base plate at an angle of 45°.

5. The sealing head as claimed in claim 2 wherein said lip seal is vulcanized or bonded to a flange-like land projecting from the base plate.

6. The sealing head as claimed in clam 2 wherein said lip seal comprises an elastic material.

7. The sealing head as claimed in claim 2, wherein said lip seal is comprised of rubber or an elastomer.

8. The sealing head as claimed in claim 2 wherein said lip seal has a tapered cross-section.

9. The sealing head as claimed in claim 2 wherein said sealing lip extends in one plane.

10. The sealing head as claimed in claim 2 wherein said sealing lip extends along a curved surface.

11. The sealing head as claimed in claim 10 wherein the base plate extends along a curved surface.

12. The sealing head as claimed in claim 2 wherein the base plate has at least one opening and/or at least one pressurized gas connection.

13. The sealing head as claimed in claim 2 wherein the base plate is comprised of metal or plastic.

14. The sealing head as claimed in claim 2 wherein the base plate and the lip seal are manufactured integrally from a plastic material.
